(19) United States
(12) Patent Application Publication
(10) Pub. No.: US 2013/0265010 A1
(43) Pub. Date: Oct. 10, 2013

(54) PROTECTIVE CIRCUIT MODULE AND BATTERY PACK

(71) Applicant: SEMICONDUCTOR ENERGY LABORATORY CO., LTD., Atsugi-shi (JP)

(72) Inventors: Masumi Nomura, Isehara (JP); Kosei Noda, Atsugi (JP)

(73) Assignee: Semiconductor Energy Laboratory Co., Ltd., Atsugi-shi (JP)

(21) Appl. No.: 13/832,617

(22) Filed: Mar. 15, 2013

(30) Foreign Application Priority Data
Apr. 6, 2012 (JP) 2012-086976

(51) Int. Cl. H02J 7/00

(52) U.S. Cl. CPC H02J 7/0031; H02J 7/0068
USPC 320/134

(57) ABSTRACT

Leakage current of a transistor used for a current interruption switch in a protective circuit of a battery pack is reduced, and a protective circuit module and a battery pack which have high safety and long lifetime can be provided. The protective circuit module includes a protective circuit, a charge control switch, and a discharge control switch. The charge control switch and the discharge control switch are connected to the protective circuit; the protective circuit detects voltage of the secondary battery, compares the voltage with a predetermined voltage, and outputs a control signal in accordance with the comparison result, so that the charge control switch or the discharge control switch is turned on or tuned off; and the charge control switch and the discharge control switch each include a transistor including an oxide semiconductor and a diode connected in parallel to the transistor including the oxide semiconductor.

### BACKGROUND OF THE INVENTION

1. Field of the Invention

The present invention relates to a protective circuit module and a battery pack. The protective circuit module includes a protective circuit and other semiconductor elements (e.g., transistors). The battery pack includes the protective circuit module and a secondary battery.

2. Description of the Related Art

When a secondary battery such as a lithium secondary battery incorporated in a battery pack is overcharged or overdischarged, deterioration occurs due to generation of side reaction and lifetime of the secondary battery is shortened. Further, the secondary battery might catch fire by an internal short-circuit. Thus, a protective circuit module by which power supply is stopped when battery voltage is higher than or equal to the overcharge voltage or low than or equal to overdischarge voltage is used.

The protective circuit module includes a protective circuit which monitors voltage and charge and discharge current of a secondary battery, a switch which interrupts current, and the like. The protective circuit has a function of interrupting input and output of power in a battery pack by control of a current interruption switch when abnormalities of the secondary battery are detected.

The protective circuit operates when discharge of the secondary battery proceeds such that battery voltage is lower than the discharge lower limit voltage, and discharge current flowing into an external load is interrupted by the current interruption switch, whereby overdischarge of the secondary battery is prevented.

Further, the protective circuit operates when charge proceeds such that battery voltage is higher than the charge upper limit voltage, and charge current flowing into the secondary battery is interrupted by the current interruption switch, whereby overcharge of the secondary battery is prevented (for example, see Patent Document 1).

### REFERENCE

[Patent Document 1] Japanese Published Patent Application No. 2010-187532

### SUMMARY OF THE INVENTION

As described above, the protective circuit monitors voltage and charge and discharge current of the secondary battery and controls the current interruption switch to interrupt an electrical path between the secondary battery and the outside, whereby overcharge and overdischarge of the secondary battery are prevented.

The path between the secondary battery and the outside is electrically interrupted by the control of the switch. However, since it is not physically interrupted, off-state current of a transistor used for the switch may flow.

Accordingly, even in the case where the transistor used for the switch is turned off for preventing overdischarge, for example, the discharge gradually proceeds when the secondary battery and an external load are connected to each other. Thus, overdischarge gradually proceeds, which may cause deterioration, a breakage, or the like of the secondary battery.

Similarly, in the case where the switch is turned off by overcharge, the overcharge gradually proceeds by the off-state current of the transistor used for the switch, which may cause a breakage or the like of the secondary battery.

In one embodiment of the present invention, in view of the above problems, it is an object of the present invention to reduce leakage current of a transistor used for a current interruption switch in a protective circuit of a battery pack and to provide a protective circuit module and a battery pack which have high safety and long lifetime.

One embodiment of the present invention is a protective circuit module including a protective circuit, a charge control switch, and a discharge control switch. The charge control switch and the discharge control switch are electrically connected to the protective circuit. The protective circuit detects voltage of the secondary battery, compares the voltage with a predetermined voltage, and outputs a control signal in accordance with the comparison result, so that the charge control switch or the discharge control switch is turned on or turned off. The charge control switch and the discharge control switch each include a transistor including an oxide semiconductor and a diode connected in parallel to the transistor including the oxide semiconductor.

One embodiment of the present invention is a protective circuit module in which a gate of the transistor is electrically connected to the protective circuit.

In one embodiment of the present invention, the diode is preferably a diode including an oxide semiconductor.

One embodiment of the present invention is a protective circuit module in which an oxide semiconductor contains at least one element selected from In, Ga, Sn, and Zn.

One embodiment of the present invention is a protective circuit module in which the charge control switch and the discharge control switch are each stacked over the protective circuit.

One embodiment of the present invention is a battery pack including a protective circuit module and a secondary battery. In the battery pack, the secondary battery, the charge control switch, and the discharge control switch are connected in series.

In one embodiment of the present invention, a lithium secondary battery can be used as the secondary battery. Note that, a lithium secondary battery refers to a secondary battery using lithium ions as carrier ions. Examples of carrier ions which can be used instead of lithium ions include alkali-metal ions such as sodium ions and potassium ions; alkaline-earth metal ions such as calcium ions, strontium ions, and barium ions; beryllium ions; magnesium ions; and the like.

According to one embodiment of the present invention, leakage current of a transistor used for a current interruption switch in a protective circuit of a battery pack can be reduced and a protective circuit module and a battery pack which have high safety and long lifetime can be provided.

### BRIEF DESCRIPTION OF THE DRAWINGS

In the accompanying drawings:

FIGS. 1A and 1B are circuit diagrams illustrating a battery pack and diodes according to one embodiment of the present invention;

FIGS. 2A and 2B are circuit diagrams each illustrating a battery pack according to one embodiment of the present invention;

FIG. 3 is a circuit diagram illustrating a battery pack according to one embodiment of the present invention;

FIG. 4 is a cross-sectional view illustrating a transistor according to one embodiment of the present invention; and

FIGS. 5A to 5F are diagrams each illustrating an electronic device.

### DETAILED DESCRIPTION OF THE INVENTION

Embodiments of the invention will be described below with reference to the accompanying drawings. Note that the present invention is not limited to the description below, and it is easily understood by those skilled in the art that various changes and modifications can be made without departing from the spirit and scope of the present invention. Therefore, the invention should not be construed as being limited to the description in the following embodiments. Note that the same portions or portions having the same function in the structure of the present invention described below are denoted by the same reference numerals in common among different drawings and repetitive description thereof will be omitted.

Note that in each drawing described in this specification, the size, the film thickness, or the region of each component is exaggerated for clarity in some cases. Therefore, embodiments of the present invention are not limited to such scales.

Note that terms such as “first”, “second”, and “third” in this specification are used in order to avoid confusion among components, and the terms do not limit the components numerically. Therefore, for example, the term “first” can be replaced with the term “second”, “third”, or the like as appropriate.

In addition, in this specification, when one of a source and a drain of a transistor is called a drain, the other is called a source. That is, they are not distinguished depending on the potential level. Therefore, a portion called a source in this specification can be alternatively referred to as a drain.

In this specification, a gate of a transistor is referred to as a “gate” or a “gate electrode”, and these terms are not distinguished from each other. In addition, a source and a drain of a transistor are referred to as a “source” and a “drain”, a “source region” and a “drain region”, or a “source electrode” and a “drain electrode”, respectively, and these terms are not distinguished from each other.

### Embodiment 1

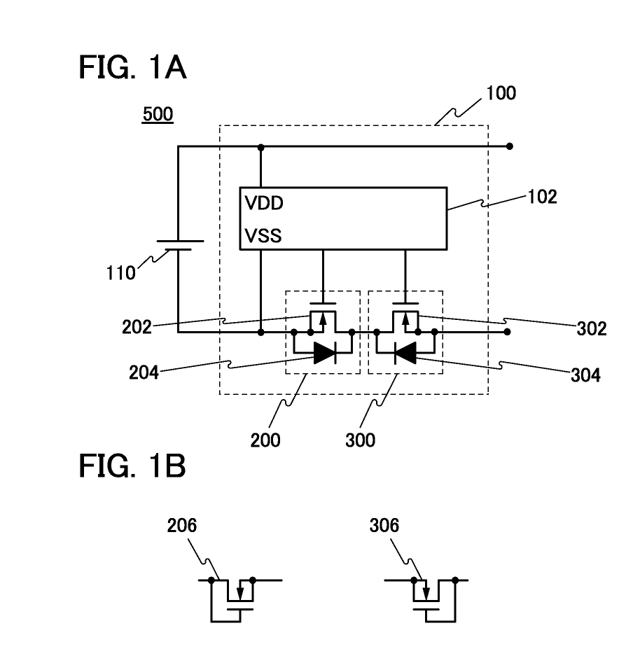

FIGS. 1A and 1B are circuit diagrams illustrating configuration examples of a battery pack 500 of one embodiment of the present invention.

As illustrated in FIG. 1A, the battery pack 500 includes a protective circuit module 100 and a secondary battery 110. Note that FIG. 1B illustrates circuit diagrams that are another embodiments of the diode 204 and the diode 304 in the protective circuit module 100 in FIG. 1A.

The protective circuit module 100 includes a protective circuit 102, a discharge control switch 200, and a charge control switch 300. The protective circuit 102 is connected in parallel to the secondary battery 110, detects a potential of the secondary battery with a VDD terminal and a VSS terminal, and controls the discharge control switch 200 and the charge control switch 300 in accordance with the result. Further, the protective circuit 102 may have a function of detecting current (charge current) supplied to the secondary battery 110 at the time of charging the secondary battery 110. Furthermore, the protective circuit 102 may have a function of detecting current (discharge current) supplied from the secondary battery 110 at the time of discharging the secondary battery 110.

As the secondary battery 110, for example, a lead-acid battery, a nickel-cadmium battery, a nickel-hydride battery, a fuel battery, an air battery, a lithium secondary battery, or the like can be used. A capacitor (e.g., lithium ion capacitor) may be used instead of the secondary battery.

Further, a plurality of secondary batteries 110 can be provided. The secondary batteries 110 may be connected in series in accordance with a required electromotive force, which may be connected to the protective circuit 102 so as to detect the potentials of the secondary batteries 110.

In the discharge control switch 200, a transistor 202 and the diode 204 are connected in parallel. Further, in the charge control switch 300, a transistor 302 and the diode 304 are connected in parallel.

Further, the discharge control switch 200 and the charge control switch 300 are connected in series with the secondary battery 110. The discharge control switch 200 and the charge control switch 300 are provided in a charge and discharge path connected to the outside; thus, overcharge and overdischarge can be prevented by electrical interruption of the discharge control switch 200 and the charge control switch 300.

In the case where the voltage of the secondary battery 110 is lower than or equal to the discharge-prohibiting voltage by discharge, the path between the secondary battery 110 and the outside is interrupted by the control of the discharge control switch 200.

In the case where the voltage of the secondary battery 110 is higher than or equal to the full charge voltage by charge, the path between the secondary battery 110 and the outside is interrupted by the control of the charge control switch 300.

Such operation allows overcharge or overdischarge of the secondary battery to be prevented. However, the discharge control switch 200 and the charge control switch 300 are each formed using the transistor and the diode, and leakage current (also referred to as off-state leakage current) in the off state of the transistor 202 or the transistor 302 flows even in the case where the discharge control switch 200 and the charge control switch 300 are cut off by turning off the transistor 202 or the transistor 302 in accordance with the control signal from the protective circuit 102. Accordingly, overdischarge or overcharge of the secondary battery gradually proceeds.

Thus, as described in one embodiment of the present invention, off-state leakage current can be reduced by the use of transistors including oxide semiconductors as the transistors included in the discharge control switch 200 and the charge control switch 300, so that deterioration of the secondary battery due to overcharge and overdischarge can be suppressed.

Further, a diode including an oxide semiconductor is preferably used as the diode included in each of the discharge control switch 200 and the charge control switch 300. For example, the diode can be formed with the use of a p-type silicon wafer and an n-type oxide semiconductor.

For example, an In—Ga—Zn-based oxide or the like can be used as the oxide semiconductor in this invention. Such an oxide semiconductor has an energy gap of 2 eV or more, preferably 2.5 eV or more, more preferably 3 eV or more. The off-state leakage current of the transistor and the diode can be reduced by using an oxide semiconductor having a wide energy gap.

Further, since an oxide semiconductor has a wide energy gap, a transistor and a diode which withstand high voltage can be formed.

As described above, the use of the transistor and the diode each of which includes an oxide semiconductor for the discharge control switch 200 and the charge control switch 300 enables off-state leakage current in the discharge control switch 200 and the charge control switch 300 to be reduced; therefore, deterioration of the secondary battery due to the overcharge and overdischarge can be suppressed.

The diodes are not limited to the diode 204 and the diode 304 which are illustrated in FIG. 1A, and may be any elements having diode characteristics. For example, as illustrated in FIG. 1B, a diode-connected transistor 206 and a diode-connected transistor 306 can be used instead of the diode 204 and the diode 304, respectively.

The formation of the elements having diode characteristics using the transistors as mentioned above is preferable because manufacturing steps of the discharge control switch 200 and the charge control switch 300 can be simplified. Further, the use of the oxide semiconductor for each of the diode-connected transistor 206 and the diode-connected transistor 306 enables the off-state leakage current to be reduced, whereby deterioration of the secondary battery due to the overcharge and overdischarge can be suppressed.

The oxide semiconductor in one embodiment of the present invention can be formed by a sputtering method or the like and does not need a high-temperature process. Thus, a multilayer structure formed of a stack of transistors including a thin oxide semiconductor film can be easily provided.

Further, in this embodiment, the transistor 202, the transistor 302, the diode-connected transistor 206, and the diode-connected transistor 306 are n-type transistors; however, the present invention is not limited to this, and p-type transistors may be used.

The oxide semiconductor film in one embodiment of the present invention can be in a single crystal state, a polycrystalline (also referred to as polycrystal) state, an amorphous state, or the like.

Preferably, a CAAC-OS (c-axis aligned crystalline oxide semiconductor) film can be used as the oxide semiconductor film.

An oxide semiconductor film may be in a non-single-crystal state, for example. The non-single-crystal state is, for example, structured by at least one of c-axis aligned crystal (CAAC), polycrystal, microcrystal, and an amorphous part. The density of defect states of an amorphous part is higher than those of microcrystal and CAAC. The density of defect states of microcrystal is higher than that of CAAC. Note that an oxide semiconductor including CAAC is referred to as a CAAC-OS (c-axis aligned crystalline oxide semiconductor).

The oxide semiconductor film may include a CAAC-OS, for example. In the CAAC-OS, for example, c-axes are aligned, and a-axes and/or b-axes are not macroscopically aligned.

For example, an oxide semiconductor film may include microcrystal. Note that an oxide semiconductor including microcrystal is referred to as a microcrystalline oxide semiconductor. A microcrystalline oxide semiconductor film includes microcrystal (also referred to as nanocrystal) with a size greater than or equal to 1 nm and less than 10 nm, for example.

For example, an oxide semiconductor film may include an amorphous part. Note that an oxide semiconductor including an amorphous part is referred to as an amorphous oxide semiconductor. An amorphous oxide semiconductor film, for example, has disordered atomic arrangement and no crystalline component. Alternatively, an amorphous oxide semiconductor film is, for example, absolutely amorphous and has no crystal part.

Note that an oxide semiconductor film may be a mixed film including any of a CAAC-OS, a microcrystalline oxide semiconductor, and an amorphous oxide semiconductor. The mixed film, for example, includes a region of an amorphous oxide semiconductor, a region of a microcrystalline oxide semiconductor, and a region of a CAAC-OS. Further, the mixed film may have a stacked structure including a region of an amorphous oxide semiconductor, a region of a microcrystalline oxide semiconductor, and a region of a CAAC-OS, for example.

Note that an oxide semiconductor film may be in a single-crystal state, for example.

An oxide semiconductor film preferably includes a plurality of crystal parts. In each of the crystal parts, a c-axis is preferably aligned in a direction parallel to a normal vector of a surface where the oxide semiconductor film is formed or a normal vector of a surface of the oxide semiconductor film. Note that, among crystal parts, the directions of the a-axis and the b-axis of one crystal part may be different from those of another crystal part. An example of such an oxide semiconductor film is a CAAC-OS film.

The CAAC-OS film is not absolutely amorphous. Note that in most cases, the crystal part fits inside a cube whose one side is less than 100 nm. In an image obtained with a transmission electron microscope (TEM), a boundary between an amorphous part and a crystal part and a boundary between crystal parts in the CAAC-OS film are not clearly detected. Further, with the TEM, a grain boundary in the CAAC-OS film is not clearly detected. Thus, in the CAAC-OS film, a reduction in electron mobility, due to the grain boundary, is suppressed.

In each of the crystal parts included in the CAAC-OS film, for example, a c-axis is aligned in a direction parallel to a normal vector of a surface where the CAAC-OS film is formed or a normal vector of a surface of the CAAC-OS film. Further, in each of the crystal parts, metal atoms are arranged in a triangular or hexagonal configuration when seen from the direction perpendicular to the a-b plane, and metal atoms are arranged in a layered manner or metal atoms and oxygen atoms are arranged in a layered manner when seen from the direction perpendicular to the c-axis. Note that, among crystal parts, the directions of the a-axis and the b-axis of one crystal part may be different from those of another crystal part. In this specification, a term “perpendicular” includes a range from 80° to 100°, preferably from 85° to 95°. In addition, a term “parallel” includes a range from —10° to 10°, preferably from −5° to 5°.

In the CAAC-OS film, distribution of crystal parts is not necessarily uniform.

For example, in the formation process of the CAAC-OS film, in the case where crystal growth occurs from a surface side of the oxide semiconductor film, the proportion of crystal parts in the vicinity of the surface of the oxide semiconductor film is higher than that in the vicinity of the surface where the oxide semiconductor film is formed in some cases. Further, when an impurity is added to the CAAC-OS film, the crystal part in a region to which the impurity is added becomes amorphous in some cases.

Since the c-axes of the crystal parts included in the CAAC-OS film are aligned in the direction parallel to a normal vector of a surface where the CAAC-OS film is formed or a normal vector of a surface of the CAAC-OS film, the directions of the c-axes may be different from each other depending on the shape of the CAAC-OS film (the cross-sectional shape of the surface where the CAAC-OS film is formed or the cross-sectional shape of the surface of the CAAC-OS film). Note that the film deposition is accompanied with the formation of the crystal parts or followed by the formation of the crystal parts through crystallization treatment such as heat treatment. Hence, the c-axes of the crystal parts are aligned in the direction parallel to a normal vector of the surface where the CAAC-OS film is formed or a normal vector of the surface of the CAAC-OS film.

With the use of the CAAC-OS film in a transistor, change in electric characteristics of the transistor due to irradiation with visible light or ultraviolet light is small. Thus, the transistor has high reliability.

Note that part of oxygen included in the oxide semiconductor film may be substituted with nitrogen.

With the use of the CAAC-OS film described above for a transistor, the transistor with lower leakage current can be formed.

### (Control Operation in Overdischarge)

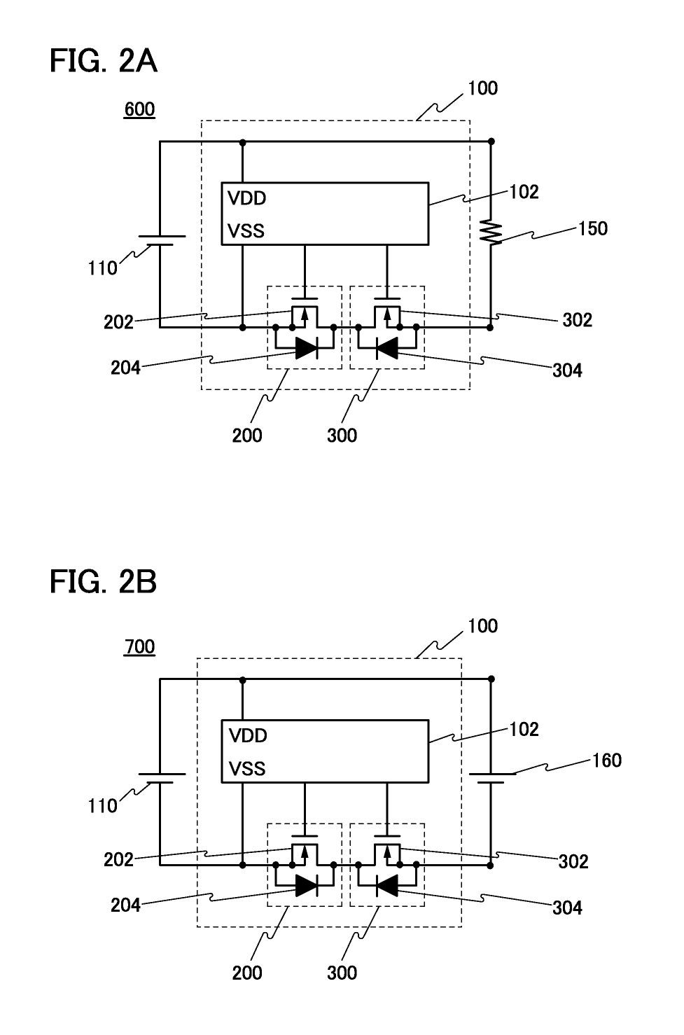

Next, operation at the time when the secondary battery 110 is overdischarged will be described with reference to FIG. 2A. FIG. 2A is a battery pack 600 in which an external load 150 is connected to the battery pack illustrated in FIG. 1A. Note that a resistor is illustrated as the external load 150 in FIG. 2A; however, it is not limited thereto, and the one by which power from the secondary battery 110 is consumed may be used.

In the battery pack 600, in the case where the voltage of the secondary battery 110 is lower than or equal to the discharge-prohibiting voltage at the time when the secondary battery 110 is discharged so that power is supplied to the external load 150, the protective circuit 102 outputs a control signal to the transistor 202 in the discharge control switch 200, whereby the transistor 202 is turned off. Thus, a discharge path from the secondary battery 110 is interrupted and overdischarge can be prevented. After that, when the secondary battery 110 is charged and the potential of the secondary battery 110 is increased, the protective circuit 102 detects the potential and outputs a control signal to the transistor 202, whereby the transistor 202 is turned on.

### (Control Operation in Overcharge)

Next, operation at the time when the secondary battery 110 is overcharged will be described with reference to FIG. 2B. FIG. 2B is a battery pack 700 in which a charging power supply 160 is connected to the battery pack illustrated in FIG. 1A. Other than the charging power supply 160 illustrated in FIG. 2B, the one which supplies power to the secondary battery 110 may be connected to the battery pack.

In the battery pack 700, in the case where the voltage of the secondary battery 110 is higher than or equal to the full charge voltage at the time when the secondary battery 110 is supplied with power from the charging power supply 160 so that the secondary battery 110 is charged, the protective circuit 102 outputs a control signal to the transistor 302 in the charge control switch 300, whereby the transistor 302 is turned off. Thus, a charge path from the charging power supply 160 is interrupted and overdischarge can be prevented. After that, when the secondary battery 110 is discharged and the potential of the secondary battery 110 is decreased, the protective circuit 102 detects the potential of the secondary battery and outputs a control signal to the transistor 302, whereby the transistor 302 is turned on.

Such operation allows the overdischarge and overcharge of the secondary battery to be prevented.

As described in the embodiment of the present invention, the use of an oxide semiconductor, preferably a CAAC-OS film for a transistor used for a current interruption switch in a protective circuit of a battery pack enables the off-state leakage current of the transistor to be reduced; thus, a protective circuit module and a battery pack which have high safety and long lifetime can be provided.

### Embodiment 2

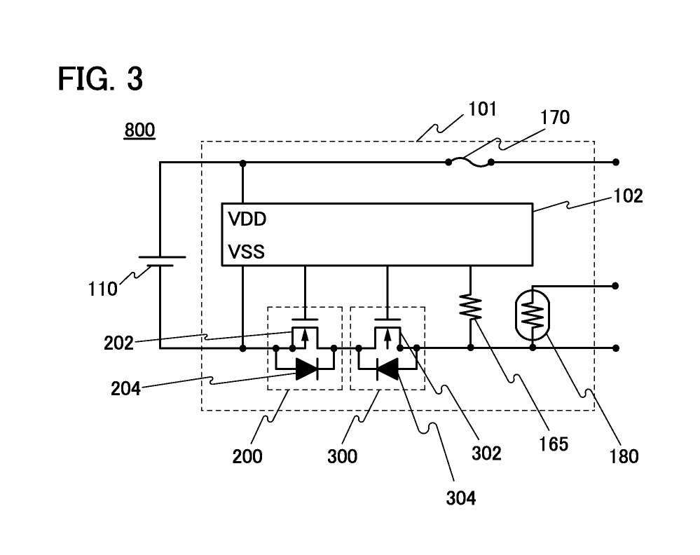

Next, a circuit configuration of a battery pack that is different from the battery pack 500 described in Embodiment 1 will be described with reference to FIG. 3.

A battery pack 800 illustrated in FIG. 3 includes a protective circuit module 101 provided with a protective resistor 165, a fuse 170, and a thermistor 180 in addition to the protective circuit module 100 described in Embodiment 1. The protective circuit module 101 provided with the protective resistor 165, the fuse 170, and the thermistor 180 is illustrated in FIG. 3; however, a structure in which one or more of the protective resistor 165, the fuse 170, and the thermistor 180 are included may be employed.

The protective resistor 165 is connected to the protective circuit 102; accordingly, current flowing in a charge and discharge path is detected in the protective circuit 102. The protective resistor 165 is a resistor for preventing a breakage of the battery pack 800 due to abnormal large current flowing in the charge and discharge path connected to the secondary battery 110. The protective resistor 165 can prevent deterioration of the secondary battery due to large current flowing in the circuit and a breakage of the protective circuit from occurring, in the case where a positive electrode and a negative electrode of the battery pack are short-circuited. In the case where abnormal current is detected, the discharge control switch 200 and the charge control switch 300 are both interrupted.

The fuse 170 is provided for the same purpose as the protective resistor 165, which is an element for preventing a breakage of the battery pack 800 due to the abnormal large current flowing in the charge and discharge path connected to the secondary battery 110. Unlike the protective resistor 165, which detects abnormal current and then electrically interrupts the discharge control switch 200 and the charge control switch 300, the fuse 170 is provided in the charge and discharge path and is melted by generation of joule heat due to the abnormal current flowing in the fuse 170, so that the charge and discharge path is physically interrupted.

The thermistor 180 is a resistor whose electrical resistance greatly changes with temperature, which functions as a sensor for measuring a temperature by detection of the resistance value. By the provision of the thermistor 180, the temperature of the secondary battery 110 can be monitored so as not to exceed an allowable temperature at the time of charging and discharging. Further, a structure may be employed in which the thermistor 180 is connected to the protective circuit 102 and a circuit for detecting a temperature from the resistance value of the thermistor 180 is provided in the protective circuit 102. Accordingly, in the case where the temperature detected by the thermistor 180 is an abnormal temperature, the protective circuit 102 outputs a control signal to the discharge control switch 200 and the charge control switch 300, whereby the charge and discharge path can be interrupted.

As described above, also in the battery pack of this embodiment, the use of an oxide semiconductor, preferably a CAAC-OS film for the transistor used for the current interruption switch in the protective circuit of the battery pack enables the off-state leakage current of the transistor to be reduced; therefore, a protective circuit module and a battery pack which have high safety and long lifetime can be provided.

### Embodiment 3

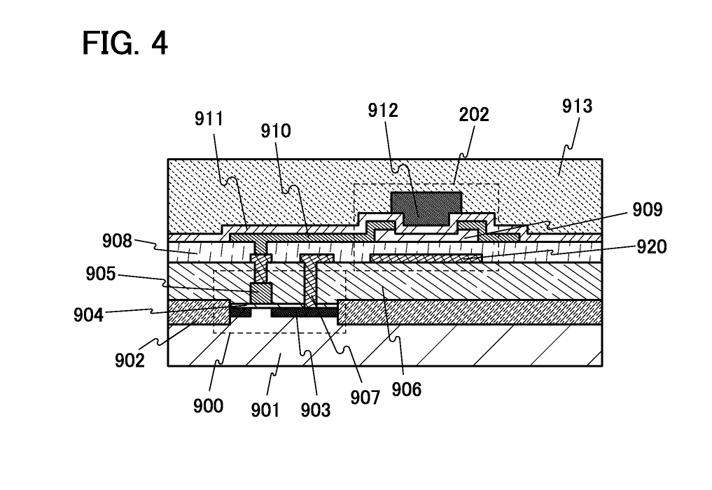

In this embodiment, an example of structures of a transistor 900 included in the protective circuit 102 described in Embodiment 1 and the transistor 202 included in the discharge control switch 200 (the same applies to the transistor 302 in the charge control switch 300) will be described using the cross-sectional view in FIG. 4.

In this embodiment, the transistor 900 is a transistor including part of a semiconductor substrate 901 and the transistor 202 is a transistor including an oxide semiconductor; however, the structure is not limited thereto. The structure in which the transistor 202 is stacked over the transistor 900 is shown; however, the stacked order may be reversed and the transistors may be formed over one surface.

The transistor 900 includes the semiconductor substrate 901, an element isolation insulating film 902 provided over the semiconductor substrate 901, a gate insulating film 904 over the semiconductor substrate 901, a gate electrode 905 over the gate insulating film 904, a source region and a drain region 903 which are formed in portions of the semiconductor substrate 901, which do not overlap with the gate electrode 905, an interlayer insulating film 906, and a wiring 907 connected to the source region and drain region 903 in contact holes formed by processing the interlayer insulating film 906.

The transistor 202 includes a base insulating film 908, an oxide semiconductor film 909 over the base insulating film 908, a source electrode and drain electrode 910 in contact with the oxide semiconductor film 909, a gate insulating film 911 over the source electrode and drain electrode 910, a gate electrode 912 which is over the gate insulating film 911 and overlaps with the oxide semiconductor film 909, and an interlayer insulating film 913 over the gate electrode 912 and the gate insulating film 911.

As illustrated in FIG. 4, a back gate electrode 920 may be formed on a back channel side of the transistor 202 with the base insulating film 908 provided therebetween. The back gate electrode 920 may be formed using the same layer as the wiring 907 as illustrated in FIG. 4 or may be separately provided. The provision of the back gate electrode 920 enables the threshold voltage of the transistor 202 to be easily controlled.

The transistor 202 has a top gate structure; however, it may have a bottom gate structure.

As the semiconductor substrate 901, a single crystal silicon substrate (a silicon wafer), or a compound semiconductor substrate (e.g., a SiC substrate or a GaN substrate) can be used. In this embodiment, the case where a p-type silicon substrate is used is described.

Instead of the semiconductor substrate 901, the following substrate may be used as a silicon on insulator (SOI) substrate, a so-called SIMOX (separation by implanted oxygen) substrate, which is formed in such a manner that after an oxygen ion is implanted into a mirror-polished wafer, an oxide layer is formed at a certain depth from the surface and defects generated in a surface layer are eliminated by high temperature heating, or an SOI substrate formed by using a technique called a Smart-Cut method in which an semiconductor substrate is cleaved by utilizing growth of a minute void formed by implantation of a hydrogen ion, by thermal treatment, an ELTRAN (epitaxial layer transfer: a registered trademark of Canon Inc.) method, or the like.

The element isolation insulating film 902 is formed by a local oxidation of silicon (LOCOS) method, a shallow trench isolation (STI) method, or the like.

The gate insulating film 904 can be formed using a silicon oxide film which is obtained by application of heat treatment in an oxygen atmosphere (also referred to as a thermal oxidation method) so that the surface of the semiconductor substrate 901 is oxidized. Alternatively, the gate insulating film 904 can be formed with a stacked structure including a silicon oxide film and a silicon film containing oxygen and nitrogen (silicon oxynitride film) by forming the silicon oxide film by a thermal oxidation method and then nitriding the surface of the silicon oxide film by nitridation treatment. Further alternatively, the gate insulating film 904 can be formed by a deposition method such as a plasma CVD method.

Further alternatively, the gate insulating film 904 can be formed using a metal oxide such as tantalum oxide, hafnium oxide, hafnium silicate oxide, zirconium oxide, or aluminum oxide, which is a high dielectric constant material (also referred to as a high-k material), a rare-earth oxide such as lanthanum oxide, or the like by a CVD method, a sputtering method, or the like.

The gate electrode 905 can be formed using a metal selected from tantalum, tungsten, titanium, molybdenum, chromium, niobium, and the like, or an alloy material or a compound material including any of the metals as its main component. Alternatively, polycrystal silicon to which an impurity element such as phosphorus is added can be used. Alternatively, the gate electrode 905 may have a stacked structure including a metal nitride film and a film of any of the above metals. As the metal nitride, tungsten nitride, molybdenum nitride, or titanium nitride can be used. When the metal nitride film is provided, adhesiveness of the metal film can be increased; accordingly, separation can be prevented.

Note that sidewall insulating films may be formed on the side surfaces of the gate electrode 905. By the provision of the side wall insulating films, an electric field between the source and drain of the transistor can be alleviated, whereby reliability of the element can be improved.

The source region and drain region 903 can be formed by addition of an impurity element imparting conductivity to the semiconductor substrate 901 using the gate electrode 905 as a mask. The source region and drain region 903 can be formed in a self-aligned manner with the use of the gate electrode 905 as a mask. In this embodiment, the source region and drain region 903 formed using n-type silicon may be formed by addition of phosphorus (P) which imparts n-type conductivity to the p-type silicon substrate.

The interlayer insulating film 906 may be formed with a single layer or a stack including one or more of silicon oxide, silicon oxynitride, silicon nitride oxide, silicon nitride, aluminum oxide, aluminum oxynitride, aluminum nitride oxide, aluminum nitride, and the like. Note that the interlayer insulating film 906 is formed using silicon nitride by a CVD method, whereby a film containing a large amount of hydrogen can be formed as the interlayer insulating film 906. Heat treatment is performed using such an interlayer insulating film 906, whereby it is possible to diffuse hydrogen to the semiconductor substrate, to terminate a dangling bond in the semiconductor substrate by hydrogen, and to reduce defects in the semiconductor substrate.

Note that planarity of the interlayer insulating film 906 can be high when the interlayer insulating film 906 is formed using an inorganic material such as boron phosphorus silicate glass (BPSG), or an organic material such as polyimide or acrylic.

The wiring 907 is formed with a single layer or a stack using any of metals such as aluminum, titanium, chromium, nickel, copper, yttrium, zirconium, molybdenum, silver, tantalum, and tungsten and an alloy containing any of these metals as a main component. For example, a single-layer structure of an aluminum film containing silicon, a two-layer structure in which a titanium film is stacked over an aluminum film, a two-layer structure in which a titanium film is stacked over a tungsten film, a two-layer structure in which a copper film is formed over a copper-magnesium-aluminum alloy film, and a three-layer structure in which a titanium film, an aluminum film, and a titanium film are stacked in this order can be given. Note that a transparent conductive material containing indium oxide, tin oxide, or zinc oxide may be used.

Further, the wiring 907 can function as a back gate electrode of the transistor 202.

The base insulating film 908 may be formed with a single layer or a stack including at least one of silicon oxide, silicon oxynitride, silicon nitride oxide, silicon nitride, aluminum oxide, aluminum nitride, hafnium oxide, zirconium oxide, yttrium oxide, gallium oxide, lanthanum oxide, cesium oxide, tantalum oxide, and magnesium oxide.

In addition, it is preferable that the base insulating film 908 be sufficiently planarized. Specifically, the base insulating film 908 is provided so as to have an average surface roughness (Ra) less than or equal to 1 nm, preferably less than or equal to 0.3 nm, more preferably less than or equal to 0.1 nm. When Ra is less than or equal to the above value, a crystal region is easily formed in the oxide semiconductor film. Note that the average surface roughness Ra is obtained by expanding arithmetic mean surface roughness that is defined by JIS B 0601: 2001 (ISO4287:1997), into three dimensions for application to a curved surface, and Ra can be expressed as the average value of the absolute values of deviations from a reference surface to a specific surface and is defined by Formula 1.

$$Ra = \frac{1}{{S}_{0}} {\int }_{y 1}^{y 2} {\int }_{x 1}^{x 2} \vert f ( x , y ) - {Z}_{0} \vert d x d y \qquad [ FORMULA 1 ]$$

Here, the specific surface is a surface which is a target of roughness measurement, and is a quadrilateral region which is specified by four points represented by the coordinates (x₁, y₁, f(x₁, y₁)), (x₁, y₂, f(x₁, y₂)), (x₂, y₁, f(x₂, y₁)), and (x₂, y₂, f(x₂, y2)). S₀ represents the area of a rectangle which is obtained by projecting the specific surface on the xy plane, and Z₀ represents the average height of the specific surface. Ra can be measured using an atomic force microscope (AFM).

Silicon oxynitride refers to a substance that contains more oxygen than nitrogen and, for example, contains oxygen, nitrogen, silicon, and hydrogen at concentrations higher than or equal to 50 at. % and lower than or equal to 70 at. %, higher than or equal to 0.5 at. % and lower than or equal to 15 at. %, higher than or equal to 25 at. % and lower than or equal to 35 at. %, and higher than or equal to 0 at. % and lower than or equal to 10 at. %, respectively. In addition, silicon nitride oxide refers to a substance that contains more nitrogen than oxygen, for example, contains oxygen, nitrogen, silicon, and hydrogen at concentrations higher than or equal to 5 at. % and lower than or equal to 30 at. %, higher than or equal to 20 at. % and lower than or equal to 55 at. %, higher than or equal to 25 at. % and lower than or equal to 35 at. %, and higher than or equal to 10 at. % and lower than or equal to 25 at. %, respectively. Note that the above ranges are ranges for cases where measurement is performed using Rutherford backscattering spectrometry (RBS) and hydrogen forward scattering spectrometry (HFS). Moreover, the total of the percentages of the constituent elements does not exceed 100 atomic %.

It is preferable that an insulating film from which oxygen is released by heat treatment be used as the base insulating film 908.

To release oxygen by heat treatment means that the released amount of oxygen which is converted into oxygen atoms is greater than or equal to 1.0×10¹⁸ atoms/cm³, preferably greater than or equal to 3.0×10²⁰ atoms/cm³ in a thermal desorption spectroscopy (TDS) analysis.

Here, a method in which the amount of released oxygen is measured by being converted into oxygen atoms using TDS analysis will be described.

The amount of released gas in TDS analysis is proportional to the integral value of a spectrum. Therefore, the amount of released gas can be calculated from the ratio between the integral value of a measured spectrum and the reference value of a standard sample. The reference value of a standard sample refers to the ratio of the density of a predetermined atom contained in a sample to the integral value of a spectrum.

For example, the number of the released oxygen molecules (N_{O2}) from an insulating film can be obtained by Formula 2 with the TDS analysis results of a silicon wafer containing hydrogen at a predetermined density which is the standard sample and the TDS analysis results of the insulating film. Here, all spectra having a mass number of 32 which are obtained by the TDS analysis are assumed to originate from an oxygen molecule. CH₃OH, which is given as a gas having a mass number of 32, is not taken into consideration on the assumption that it is unlikely to be present. Further, an oxygen molecule including an oxygen atom having a mass number of 17 or 18 which is an isotope of an oxygen atom is not taken into consideration either because the proportion of such a molecule in the natural world is minimal.

$${N}_{O 2} = \frac{{N}_{H 2}}{{S}_{H 2}} \times {S}_{O 2} \times α \qquad [ Formula 2 ]$$

N_{H2} is the value obtained by conversion of the number of hydrogen molecules desorbed from the standard sample into densities. S_{H2} is the integral value of a spectrum when the standard sample is subjected to TDS analysis. Here, the reference value of the standard sample is set to N_{H2}/S_{H2}. S_{O2} is the integral value of a spectrum when the insulating film is subjected to TDS analysis. α is a coefficient affecting the intensity of the spectrum in the TDS analysis. Refer to Japanese Published Patent Application No. H6-275697 for details of Formula 2. Note that the amount of released oxygen from the above insulating film is measured with a thermal desorption spectroscopy apparatus produced by ESCO Ltd., EMD-WA1000S/W using a silicon wafer containing a hydrogen atom at 1×10¹⁶ atoms/cm² as the standard sample.

Further, in the TDS analysis, oxygen is partly detected as an oxygen atom. The ratio between oxygen molecules and oxygen atoms can be calculated from the ionization rate of the oxygen molecules. Note that, since the above a includes the ionization rate of the oxygen molecules, the number of the released oxygen atoms can also be estimated through the evaluation of the number of the released oxygen molecules.

Note that N_{O2} is the number of the released oxygen molecules. The amount of released oxygen when converted into oxygen atoms is twice the number of the released oxygen molecules.

In the transistor including an oxide semiconductor film, oxygen is supplied from the base insulating film to the oxide semiconductor film, whereby an interface state density between the oxide semiconductor film and the base insulating film can be reduced. As a result, carrier trapping at the interface between the oxide semiconductor film and the base insulating film due to the operation of a transistor, or the like can be suppressed, and thus, the transistor can have high reliability.

Further, in some cases, charge is generated due to oxygen deficiency in the oxide semiconductor film. In general, part of oxygen vacancy in an oxide semiconductor film serves as a donor and causes release of an electron which is a carrier. As a result, the threshold voltage of a transistor shifts in the negative direction. When oxygen is sufficiently supplied from the base insulating film to the oxide semiconductor film and the oxide semiconductor film preferably contains excessive oxygen, the density of oxygen vacancies in the oxide semiconductor film, which causes the negative shift of the threshold voltage, can be reduced.

As a material for the oxide semiconductor film 909, at least indium (In) or zinc (Zn) is preferably contained. In particular, In and Zn are preferably contained. As a stabilizer for reducing variation in electrical characteristics of a transistor using the oxide semiconductor film 909, it is preferable that gallium (Ga) be additionally contained. Tin (Sn), hafnium (Hf), aluminum (Al), titanium (Ti), or zirconium (Zr) is preferably contained as a stabilizer.

As another stabilizer, one or plural kinds of lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu) may be contained.

As the oxide semiconductor, for example, any of the following can be used: indium oxide, gallium oxide, tin oxide, zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm-—n-based oxide, an In—Yb—Zn-based oxide, an In—Lu—Zn-based oxide; an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide.

The oxide semiconductor film 909 is preferably a CAAC-OS film.

In addition, in an oxide semiconductor having a crystal part, such as the CAAC-OS, defects in the bulk can be further reduced. In addition, the oxide semiconductor can have higher mobility than an amorphous oxide semiconductor by improvement in surface planarity. In order to improve the surface planarity, the oxide semiconductor is preferably formed over a flat surface. Specifically, the oxide semiconductor may be formed over a surface with the average surface roughness (Ra) of less than or equal to 1 nm, preferably less than or equal to 0.3 nm, more preferably less than or equal to 0.1 nm.

The oxide semiconductor film 909 can be formed by a sputtering method, a molecular beam epitaxy (MBE) method, a CVD method, a pulse laser deposition method, an atomic layer deposition (ALD) method, or the like as appropriate. Alternatively, the oxide semiconductor layer 909 may be formed using a sputtering apparatus which performs film formation with surfaces of a plurality of substrates set substantially perpendicular to a surface of a sputtering target.

The oxide semiconductor film 909 is preferably a highly purified oxide semiconductor film which hardly contains impurities such as copper, aluminum, or chlorine. In the process for manufacturing the transistor, steps in which these impurities are not mixed into the oxide semiconductor film 909 or attached to the surface of the oxide semiconductor film 909 are preferably selected as appropriate. In the case where the impurities are attached to the surface of the oxide semiconductor film 909, the impurities on the surface of the oxide semiconductor film 909 are preferably removed by exposure to oxalic acid or dilute hydrofluoric acid or plasma treatment (such as N₂O plasma treatment). Specifically, the concentration of copper in the oxide semiconductor film 909 is lower than or equal to 1×10¹⁸ atoms/cm³, preferably lower than or equal to 1×10¹⁷ atoms/cm³. The aluminum concentration in the oxide semiconductor film is 1×10¹⁸ atoms/cm³ or less. Further, the concentration of chlorine in the oxide semiconductor film 909 is smaller than or equal to 2×10¹⁸ atoms/cm³.

A metal film containing an element selected from aluminum (Al), chromium (Cr), copper (Cu), tantalum (Ta), titanium (Ti), molybdenum (Mo), and tungsten (W), a metal nitride film containing any of the above elements as its component (e.g., a titanium nitride film, a molybdenum nitride film, or a tungsten nitride film), or the like can be used to form the source electrode and drain electrode 910. Alternatively, a film of a high-melting-point metal such as Ti, Mo, or W or a metal nitride film thereof (e.g., a titanium nitride film, a molybdenum nitride film, or a tungsten nitride film) may be formed over or/and below a metal film such as an Al film or a Cu film. Alternatively, the source electrode and drain electrode 910 may be formed using a conductive metal oxide. As the conductive metal oxide, indium oxide (In₂O₃), tin oxide (SnO₂), zinc oxide (ZnO), indium oxide-tin oxide (In₂O₃—SnO₂), indium oxide-zinc oxide (In₂O₃—ZnO), or any of these metal oxide materials in which silicon oxide is contained can be used.

The gate insulating film 911 can be formed by a plasma CVD method, a sputtering method, or the like. The gate insulating film 911 may be formed with a single layer or a stack of layers using one or more kinds of materials selected from silicon oxide, silicon oxynitride, aluminum oxide, aluminum oxynitride, hafnium oxide, gallium oxide, magnesium oxide, tantalum oxide, yttrium oxide, zirconium oxide, lanthanum oxide, and neodymium oxide.

When the gate insulating film 911 is formed using a high-k material such as hafnium oxide, yttrium oxide, hafnium silicate (HfSiₓO_{y} (x>0, y>0)), hafnium silicate to which nitrogen is added (HfSiOₓN_{y} (x>0, y>0)), hafnium aluminate (HfAlₓO_{y} (x>0, y>0)), or lanthanum oxide, gate leakage current can be reduced. The use of the gate insulating film 911 for the capacitor is preferable because it makes it possible to increase the capacitance of the capacitor. Further, the gate insulating film 911 may have a single-layer structure or a stacked structure.

The gate electrode 912 can be formed using a metal material such as molybdenum, titanium, tantalum, tungsten, aluminum, copper, chromium, neodymium, or scandium, or an alloy material which includes any of these materials as a main component. Alternatively, a semiconductor film typified by a polycrystalline silicon film doped with an impurity element such as phosphorus, or a silicide film such as a nickel silicide film may be used as the gate electrode 912. Note that the gate electrode 912 may have a single-layer structure or a stacked structure.

The gate electrode 912 can also be formed using a conductive material such as indium oxide-tin oxide, indium oxide containing tungsten oxide, indium zinc oxide containing tungsten oxide, indium oxide containing titanium oxide, indium tin oxide containing titanium oxide, indium oxide-zinc oxide, or indium tin oxide to which silicon oxide is added.

As one layer of the gate electrode layer 912, which is in contact with the gate insulating film 911, a metal oxide containing nitrogen, specifically, an In—Ga—Zn—O film containing nitrogen, an In—Sn—O film containing nitrogen, an In—Ga—O film containing nitrogen, an In—Zn—O film containing nitrogen, a Sn—O film containing nitrogen, an In—O film containing nitrogen, or a metal nitride (e.g., InN or SnN) film can be used. These films each have a work function of 5 eV (electron volts) or higher, preferably 5.5 eV or higher, which enables the threshold voltage, which is one of electric characteristics of a transistor, to be positive when used as the gate electrode layer.

The interlayer insulating film 913 may be formed using a material similar to that of the base insulating film 908.

It is preferable that the interlayer insulating film 913 have low relative permittivity and a sufficient thickness. For example, a silicon oxide film having a relative permittivity of about 3.8 and a thickness of greater than or equal to 300 nm and less than or equal to 1000 nm may be used. A surface of the interlayer insulating film 913 has a little fixed charge because of influence of atmospheric components and the like, which might cause the shift of the threshold voltage of the transistor. Therefore, it is preferable that the interlayer insulating film 913 has relative permittivity and a thickness such that the influence of the electric charge at the surface is sufficiently reduced.

The transistor 900 and the transistor 202 can be formed with the above structures. Further, the transistor 900 and the transistor 202 can be stacked, so that the area occupied by the battery pack can be reduced.

### Embodiment 4

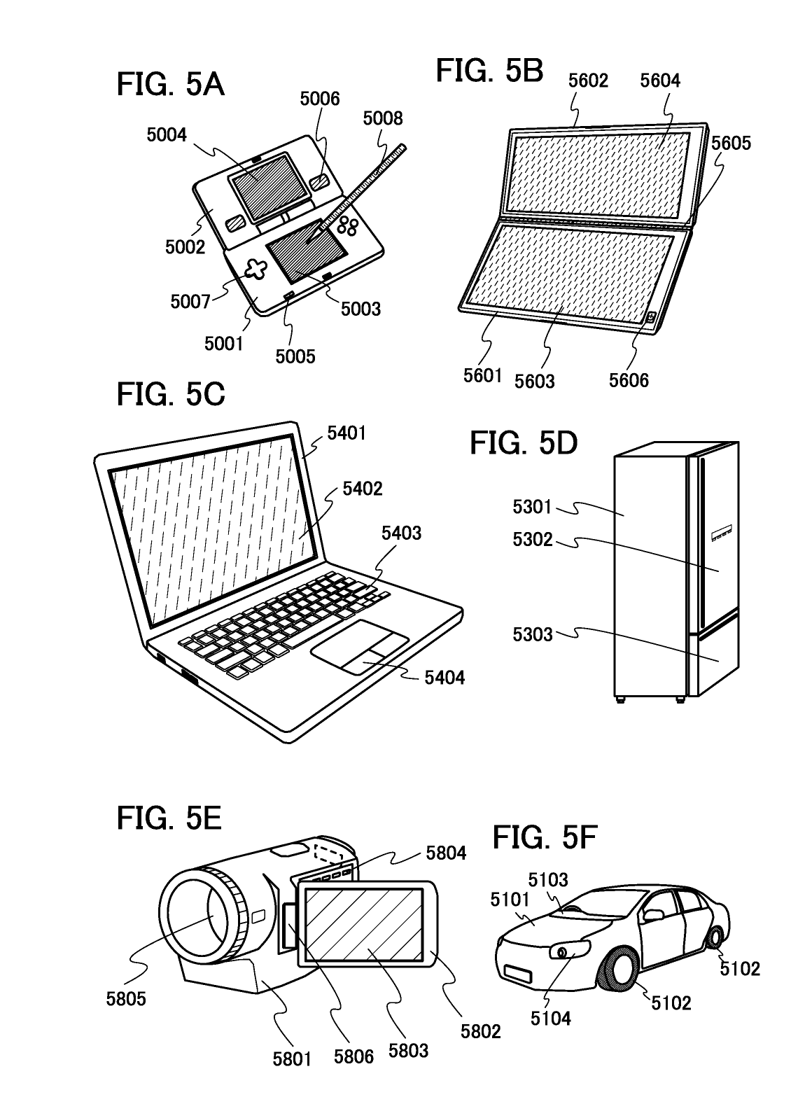

The protective circuit module or the battery pack according to one embodiment of the present invention can be used for display devices, personal computers, and image reproducing devices provided with recording media (typically, devices that reproduce the content of recording media such as digital versatile discs (DVDs) and have displays for displaying the reproduced images). Other examples of electronic devices that can include the protective circuit module or the battery pack according to one embodiment of the present invention are mobile phones, game consoles including portable game consoles, personal digital assistants, e-book readers, cameras such as video cameras and digital still cameras, goggle-type displays (head mounted displays), navigation systems, audio reproducing devices (e.g., car audio systems and digital audio players), copiers, facsimiles, printers, multifunction printers, automated teller machines (ATM), and vending machines. Specific examples of such electronic devices are illustrated in FIGS. 5A to 5F.

FIG. 5A illustrates a portable game machine, which includes a housing 5001, a housing 5002, a display portion 5003, a display portion 5004, a microphone 5005, speakers 5006, an operation key 5007, a stylus 5008, and the like. Note that although the portable game machine in FIG. 5A has the two display portions 5003 and 5004, the number of display portions included in the portable game machine is not limited thereto.

FIG. 5B illustrates a personal digital assistant, which includes a first housing 5601, a second housing 5602, a first display portion 5603, a second display portion 5604, a joint 5605, an operation key 5606, and the like. The first display portion 5603 is provided in the first housing 5601, and the second display portion 5604 is provided in the second housing 5602. The first housing 5601 and the second housing 5602 are connected to each other with the joint 5605, and the angle between the first housing 5601 and the second housing 5602 can be changed with the joint 5605. An image on the first display portion 5603 may be switched depending on the angle between the first housing 5601 and the second housing 5602 at the joint 5605. A display device with a position input function may be used as at least one of the first display portion 5603 and the second display portion 5604. Note that the position input function can be added by provision of a touch panel in a display device. Alternatively, the position input function can be added by provision of a photoelectric conversion element called a photosensor in a pixel area of a display device.

FIG. 5C illustrates a laptop, which includes a housing 5401, a display portion 5402, a keyboard 5403, a pointing device 5404, and the like.

FIG. 5D illustrates an electric refrigerator-freezer, which includes a housing 5301, a door for a refrigerator 5302, a door for a freezer 5303, and the like

FIG. 5E illustrates a video camera, which includes a first housing 5801, a second housing 5802, a display portion 5803, operation keys 5804, a lens 5805, a joint 5806, and the like. The operation keys 5804 and the lens 5805 are provided for the first housing 5801, and the display portion 5803 is provided for the second housing 5802. The first housing 5801 and the second housing 5802 are connected to each other with the joint 5806, and an angle between the first housing 5801 and the second housing 5802 can be changed with the joint 5806. The image displayed on the display portion 5803 may be switched depending on the angle in the joint 5806 between the first housing 5801 and the second housing 5802.

FIG. 5F illustrates an ordinary motor vehicle, which includes a car body 5101, wheels 5102, a dashboard 5103, lights 5104, and the like.

This embodiment can be combined with any of the other embodiments as appropriate.

This application is based on Japanese Patent Application serial no. 2012-086976 filed with Japan Patent Office on Apr. 6, 2012, the entire contents of which are hereby incorporated by reference.

What is claimed is:

1. A battery pack comprising:
a protective circuit;
a charge control switch; and
a discharge control switch,
wherein the charge control switch and the discharge control switch are electrically connected to the protective circuit, and
wherein the charge control switch and the discharge control switch each comprise a transistor comprising an oxide semiconductor.

2. The battery pack according to claim 1, wherein the oxide semiconductor comprises at least one element selected from In, Ga, Sn, and Zn.

3. The battery pack according to claim 1, wherein each of the charge control switch and the discharge control switch further comprises a diode electrically connected to the transistor.

4. The battery pack according to claim 3, wherein the diode comprises an oxide semiconductor.

5. An electronic device comprising the battery pack according to claim 1.

6. A battery pack comprising:
a secondary battery;
a protective circuit;
a charge control switch; and
a discharge control switch,
wherein the charge control switch and the discharge control switch are electrically connected to the protective circuit,
wherein the charge control switch and the discharge control switch each comprise a transistor comprising an oxide semiconductor, and
wherein the protective circuit is configured to detect voltage of the secondary battery, compare the voltage with a predetermined voltage, and output a control signal in accordance with a comparison result, so that the charge control switch or the discharge control switch is turned on or turned off.

7. The battery pack according to claim 6, wherein the oxide semiconductor comprises at least one element selected from In, Ga, Sn, and Zn.

8. The battery pack according to claim 6, wherein each of the charge control switch and the discharge control switch further comprises a diode electrically connected to the transistor.

9. The battery pack according to claim 8, wherein the diode comprises an oxide semiconductor.

10. The battery pack according to claim 6, wherein the secondary battery, the charge control switch and the discharge control switch are connected in series.

11. The battery pack according to claim 6, wherein the secondary battery and the protective circuit are connected in parallel.

12. The battery pack according to claim 6, wherein the secondary battery is a lithium secondary battery.

13. An electronic device comprising the battery pack according to claim 6.

14. A battery pack comprising:
a protective circuit;
a charge control switch; and
a discharge control switch,
wherein the charge control switch and the discharge control switch each comprise a transistor comprising an oxide semiconductor, and
wherein the charge control switch and the discharge control switch are stacked over the protective circuit.

15. The battery pack according to claim 14, wherein the oxide semiconductor comprises at least one element selected from In, Ga, Sn, and Zn.

16. The battery pack according to claim 14, wherein each of the charge control switch and the discharge control switch further comprises a diode electrically connected to the transistor.

17. The battery pack according to claim 16, wherein the diode comprises an oxide semiconductor.

18. An electronic device comprising the battery pack according to claim 14.
